(19) United States
(12) Patent Application Publication
(10) Pub. No.: US 2026/0255365 A1
(43) Pub. Date: Aug. 27, 2026

(54) DCI FORMAT WITH TYPE-1 FIELD FOR MULTI-CELL SCHEDULING

(71) Applicant: Intel Corporation, Santa Clara, CA (US)

(72) Inventors: Gang Xiong, Beaverton, OR (US); Yingyang Li, Beijing (CN); Yi Wang, Beijing (CN)

(21) Appl. No.: 19/135,455

(22) PCT Filed: Dec. 14, 2023
(86) PCT No.: PCT/US2023/084022

§ 371 Date: Jun. 4, 2025

Related U.S. Application Data
(60) Provisional application No. 63/440,350, filed on Jan. 20, 2023.
(60) Provisional application No. 63/491,940, filed on Mar. 23, 2023.

(51) Int. Cl. H04W 72/232; H04L 1/00; H04W 72/1268

(52) U.S. Cl. CPC H04W 72/232; H04L 1/001; H04W 72/1268

(57) ABSTRACT

A User Equipment (UE) configured for operation in a fifth-generation new radio (5G NR) network may decode a downlink control information (DCI) format for multi-cell scheduling that may schedule at least one physical downlink shared channel (PDSCH) or at least one physical uplink shared channel (PUSCH) over multiple cells. The DCI format may comprise a Type-1 field and a Type-2 field. The Type-1 field is a single field comprising only one of a Type-1 A field, a Type-IB field, and a Type-1C field. The Type-1 A field indicates common information for all of the multiple cells that are co-scheduled. The Type-IB field indicates separate information jointly indicated for each of the multiple cells that are co-scheduled. The Type-1C field indicates information for only one of the multiple cells that are co-scheduled. The Type-2 field comprises a separate field for each one of the multiple cells that are co¬scheduled.

### PRIORITY CLAIM

This application claims priority to U.S. Provisional Patent Application Ser. No. 63/440,350, filed Jan. 20, 2023 [reference number AF1495-Z], and U.S. Provisional Patent Application Ser. No. 63/491,940, filed Mar. 23, 2023 [reference number AF2583-Z], which are incorporated herein by reference in their entireties.

### TECHNICAL FIELD

Embodiments pertain to wireless communications.

### BACKGROUND

Mobile communications have evolved significantly from early voice systems to today's highly sophisticated integrated communication platform. With the increase in different types of devices communicating with various network devices, usage of fifth-generation new radio (5G NR) systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

5G NR systems use downlink control information (DCI) formats to send dynamic physical layer control messages from the network to each UE. This information can be system-wide or user-equipment-specific (UE-specific), and contains aspects of uplink and downlink data scheduling, HARQ management, power control, and other signalling. One issue with DCI formats is their size. Smaller DCI formats mean less bits are needed to convey the same information. This reduces the control signaling overhead, freeing up precious radio resources. The smaller size of DCI formats also reduces the processing load on base stations and devices. This enables faster scheduling decisions and more efficient data transfer. With lower overhead and processing time, smaller DCI formats directly contribute towards reducing latency in 5G networks. This is critical for emerging applications like industrial automation, autonomous vehicles etc.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2 illustrates one example of multi-cell scheduling for PDSCHs, in accordance with some embodiments; and

FIG. 3 illustrates an example of Type-2 field determination for UL/SUL operation, in accordance with some embodiments.

FIG. 4 illustrates another example of Type-2 field determination for UL/SUL operation, in accordance with some embodiments.

FIG. 5 illustrates a functional block diagram of a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to a User Equipment (UE) configured for operation in a fifth-generation new radio (5G NR) network. The UE may encode radio-resource control (RRC) signalling for transmission to a gNodeB (gNB) to indicate a UE capability for multi-cell scheduling. The UE may decode a downlink control information (DCI) format for multi-cell scheduling that may schedule at least one physical downlink shared channel (PDSCH) or at least one physical uplink shared channel (PUSCH) over multiple cells. The DCI format for multi-cell scheduling may comprise a Type-1 field and a Type-2 field. The Type-1 field being a single field comprising only one of a Type-1A field, a Type-1B field, and a Type-1C field. The Type-1A field indicates common information for all of the multiple cells within the set that are co-scheduled by the DCI format. The Type-1B field indicates separate information jointly indicated for each of the multiple cells within the set that are co-scheduled by the DCI format. The Type-1C field indicates information for only one of the multiple cells within the set that are co-scheduled by the DCI format. The Type-2 field comprises a plurality of separate fields indicating information for each one of the multiple cells of the set that that are co-scheduled by the DCI format. These embodiments, as well as others, are described in more detail below.

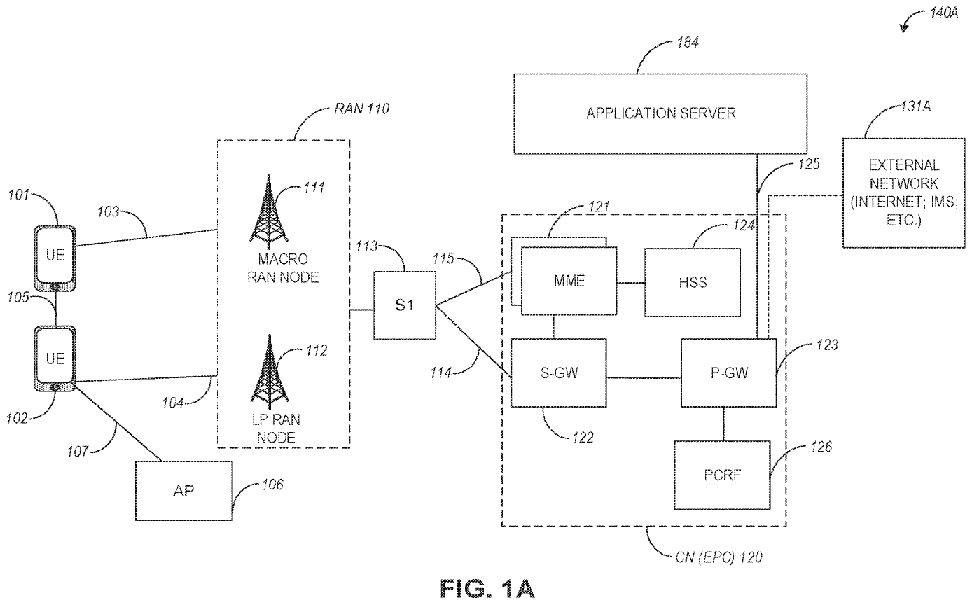

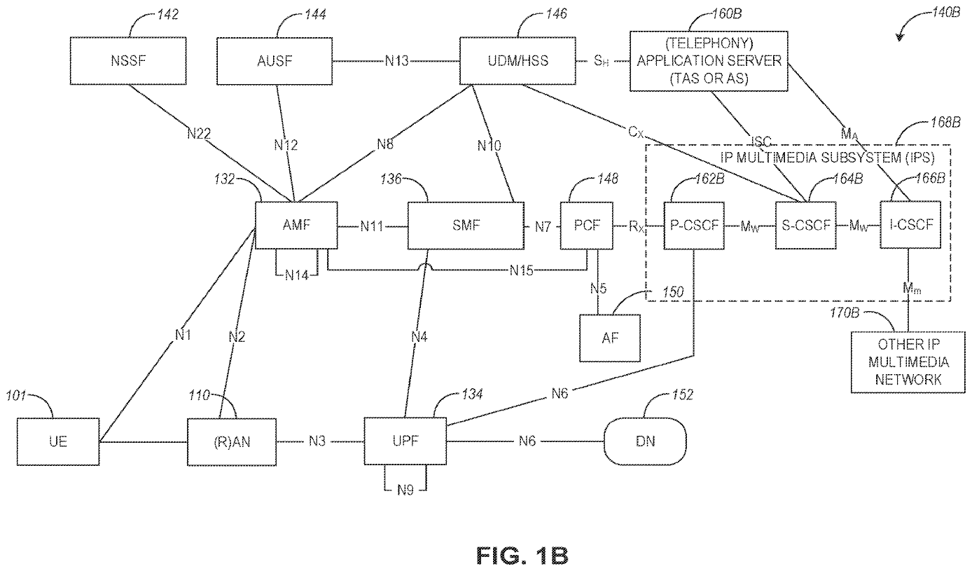

FIG. 1A illustrates an architecture of a network in accordance with some embodiments. The network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UE 101 and UE 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHZ, 3.4-3.6 GHZ, 3.6-3.8 GHz, and further frequencies and Spectrum Access System (SAS) in 3.55-3.7 GHZ and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UE 101 and UE 102 can comprise an Internet-of-Things (IoT) UE or a Cellular IoT (CIoT) UE, which can comprise a network access layer designed for low-power IoT applications utilizing short-lived UE connections. In some embodiments, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UE 101 and UE 102 can include enhanced MTC (eMTC) UEs or further enhanced MTC (FeMTC) UEs.

The UE 101 and UE 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the RAN nodes 111 and 112 can be transmission/reception points (TRPs). In instances when the RAN nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node, and one or more RAN nodes for providing femtocells or picocells (e.g., cells having smaller coverage areas, smaller user capacity, or higher bandwidth compared to macrocells), e.g., low power (LP) RAN node.

Any of the RAN nodes 111 and 112 can terminate the air interface protocol and can be the first point of contact for the UE 101 and UE 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the RAN nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the core network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. In these embodiments, the RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs 134, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

NR supports a wide range of spectrum in different frequency ranges. It is expected that there will be increasing availability of spectrum in the market for 5G Advanced possibly due to re-farming from the bands originally used for previous cellular generation networks. Especially for frequency range (FR1) bands, the available spectrum blocks tend to be more fragmented and scattered with narrower bandwidth. For FR2 bands and some FR1 bands, the available spectrum can be wider such that intra-band multi-carrier operation is necessary. To meet different spectrum needs, it is important to ensure that these scattered spectrum bands or wider bandwidth spectrum can be utilized in a more spectral/power efficient and flexible manner, thus providing higher throughput and decent coverage in the network.

One motivation is to increase flexibility and spectral/power efficiency on scheduling data over multiple cells including intra-band cells and inter-band cells. The current scheduling mechanism only allows scheduling of single cell physical uplink shared channel (PUSCH) or physical downlink shared channel (PDSCH) per a scheduling downlink control information (DCI). With more available scattered spectrum bands or wider bandwidth spectrum, the need of simultaneous scheduling of multiple cells is expected to be increasing. To reduce the control overhead, it is beneficial to extend from single-cell scheduling to multi-cell PUSCH/PDSCH scheduling with a single scheduling DCI. More specifically, a DCI is used to schedule PDSCH or PUSCH transmissions in more than one cell or component carrier (CC), where each PDSCH or PUSCH is scheduled in one cell or CC.

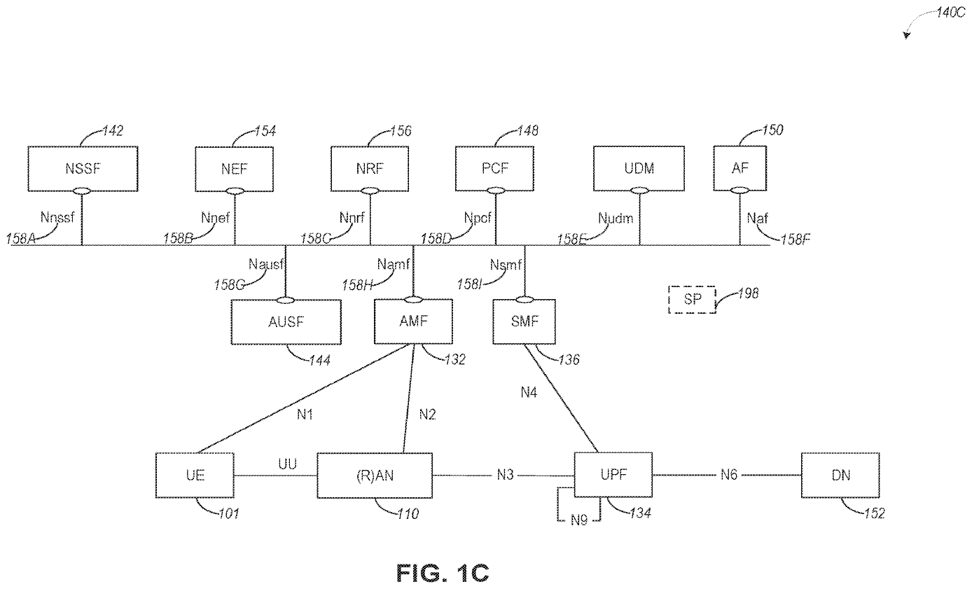

FIG. 2 illustrates one example of multi-cell scheduling for PDSCHs. In the example, one physical downlink control channel (PDCCH) is used to schedule two PDSCHs in two different cells, i.e., PDSCH #0 in CC0 and PDSCH #1 in CC1.

In some aspects, the following types of DCI fields may be considered for multi-cell scheduling:
Type-1 field:
Type-1A field: A single field indicating common information to all the co-scheduled cells
Type-1B field: A single field indicating separate information to each of co-scheduled cells via joint indication
Type-1C field: A single field indicating an information to only one of co-scheduled cells
Type-2 field: Separate field for each of the co-scheduled cells

Given that different cells may have different configurations, which may result in different field sizes for single cell scheduling, it is important to ensure the same understanding on each DCI field size for multi-cell scheduling between gNB and UE to avoid any ambiguity. In this regard, certain design on the DCI field needs to be considered for multi-cell scheduling.

Embodiments disclosed herein provide a detailed DCI field design for multi-cell scheduling including:
Detailed design for Type 1A field for multi-cell scheduling
Detailed design for Type 1B field for multi-cell scheduling
Detailed design for Type-2 field for multi-cell scheduling
Detailed design for some DCI fields

In some aspects, the following types of DCI fields may be considered for multi-cell scheduling:
Type-1 field:
Type-1A field: A single field indicating common information to all the co-scheduled cells
Type-1B field: A single field indicating separate information to each of co-scheduled cells via joint indication
Type-1C field: A single field indicating an information to only one of co-scheduled cells
Type-2 field: Separate field for each of the co-scheduled cells

In the following embodiments, DCI format 0_X is used for scheduling multiple PUSCHs on multiple cells with one PUSCH per cell and DCI format 1_X is used for scheduling multiple PDSCHs on multiple cells with one PDSCH per cell. In some embodiments, DCI format 0_X and DCI format 1_X may refer to DCI format 0_3 and DCI format 1_3 respectively, although the scope of the embodiments is not limited in this respect.

In addition, the following embodiments may apply for the scheduled or valid PDSCHs for multi-cell PDSCH scheduling. In some aspects, valid PDSCH indicates that PDSCH is actually transmitted, or not overlapping with a UL symbol indicated by tdd-UL-DL-ConfigurationCommon or tdd-UL-DL-ConfigurationDedicated if provided in each cell.

Further, the following embodiments may apply for the scheduled or valid PUSCHs for multi-cell PUSCH scheduling. In some aspects, valid PUSCH indicates that PUSCH is actually transmitted, or not overlapping with a DL symbol indicated by tdd-UL-DL-ConfigurationCommon or tdd-UL-DL-ConfigurationDedicated if provided, or a symbol of an SS/PBCH block with index provided by ssb-PositionsInBurst.

### Detailed Design for Type 1A Field for Multi-Cell Scheduling

As mentioned above, given that different cells may have different configurations, which may result in different field sizes for single cell scheduling, it is important to ensure the same understanding on each DCI field size for multi-cell scheduling between gNB and UE to avoid any ambiguity. In this regard, certain design on the DCI field needs to be considered for multi-cell scheduling.

In some aspects, the following DCI fields may be considered as Type 1A field or configurable between Type 1A and Type-2.
Bandwidth part (BWP) indicator for both DCI format 0_X and 1_X
Virtual resource block to physical resource block (VRB-to-PRB) mapping for DCI format 1_X
PRB bundling size indicator for DCI format 1_X.
Antenna port(s) for both DCI format 0_X and 1_X
Demodulation reference signal (DMRS) sequence initialization for both DCI format 0_X and 1_X
Frequency hopping flag for DCI format 0_X
Open-loop power control parameter set indication for DCI format 0_X
Precoding information and number of layers for DCI format 0_X
Sounding reference signal (SRS) resource indicator for DCI format 0_X

Embodiments of detailed design for Type 1A field for multi-cell scheduling are provided as follows:

In one embodiment, for Type 1A field, field size in DCI format 0_X and/or 1_X can be determined as maximum field size for the active bandwidth part (BWP) for each cell from configured carrier indication table for multi-cell scheduling. If the field size determined for a co-scheduled cell is 0, the field in the DCI format 0_X and/or 1_X is not applied. Further, if the field size for a co-scheduled cell is less than the determined field size in the DCI format 0_X and/or 1_X, least significant bit (LSB) or most significant bit (MSB) of the field is applied.

In some aspects, the carrier indication table can be configured by higher layers via radio resource control (RRC) signalling, where each row of the carrier indication table may consist of one or more co-scheduled cells. In one example, based on the carrier indication table, cell #0, cell #1 and cell #2 are configured for multi-cell scheduling. In this case, Type 1A field size can be determined as maximum field size for the active BWP for each cell from cell #0, cell #1 and cell #2 for multi-cell scheduling.

In another embodiment, for Type 1A field, field size in DCI format 0_X and/or 1_X can be determined as maximum field size for the active BWP for each cell from number of cells configured for multi-cell scheduling or maximum number of cells for multi-cell scheduling, i.e., 4. If the field size determined for a co-scheduled cell is 0, the field in the DCI format 0_X and/or 1_X is not applied. Further, if the field size for a co-scheduled cell is less than the determined field size in the DCI format 0_X and/or 1_X, least significant bit (LSB) or most significant bit (MSB) of the field is applied. In one example, based on the configuration for multi-cell scheduling, cell #0, cell #1, cell #2 and cell #3 are configured for multi-cell scheduling. In this case, Type 1A field size can be determined as maximum field size for the active BWP for each cell from cell #0, cell #1, cell #2 and cell #3 for multi-cell scheduling.

### Detailed Design for Type 1B Field for Multi-Cell Scheduling

In some aspects, the following DCI fields may be considered as Type 1B field:
Time domain resource allocation (TDRA) for both DCI format 0_X and 1_X
Rate matching indicator for DCI format 1_X
Zero power channel state information-reference signal (ZP CSI-RS) trigger for DCI format 1_X
Transmission Configuration Indication (TCI) for DCI format 1_X
SRS request for both DCI format 0_X and 1_X
SRS offset indicator for both DCI format 0_X and 1_X

Embodiments of detailed design for Type 1B field for multi-cell scheduling are provided as follows:

In one embodiment, for Type 1B field, a joint indication is applied, which points to a row of a table configured by RRC signalling for multi-cell scheduling. In particular, the joint indication bit field size can be determined based on the number of rows in the table. Further, each row includes M sub-fields, where M is number of actually co-scheduled cells for multi-cell scheduling associated with non-zero bit length for the corresponding bit field, which is determined based on carrier indication field in the DCI format 0_X and 1_X. Further, the sub-field is pointed to the configuration based on single-cell scheduling. If the determined sub-field size is 0, UE ignores the sub-field in the corresponding carrier in the row of the table.

In another embodiment, for Type 1B field, a joint indication is applied, which points to a row of a table configured by RRC signalling for multi-cell scheduling. In particular, the joint indication bit field size can be determined based on the number of rows in the table. Further, each row includes N sub-fields, where N is number of cells configured for multi-cell scheduling associated with non-zero bit length for the corresponding bit field. In some aspects, N can be fixed to 4 or maximum number of cells configurable for multi-cell scheduling, or can be determined in accordance with the maximum number of cells from carrier indication table. In some aspects, UE determines the corresponding field based on the carrier indication field and then determines the sub-field for each co-scheduled cell. Further, the sub-field is pointed to the configuration based on single-cell scheduling. If the determined sub-field size is 0, UE ignores the sub-field in the corresponding carrier in the row of the table.

### Detailed Design for Type-2 Field for Multi-Cell Scheduling

In some aspects, the following DCI fields may be considered as Type-2 field:
Hybrid automatic repeat request (HARQ) process number for both DCI format 0_X and 1_X
Modulation and coding scheme (MCS) for both DCI format 0_X and 1_X
Frequency domain resource allocation (FDRA) for both DCI format 0_X and 1_X
Antenna port(s) for both DCI format 0_X and 1_X
Transmit power control (TPC) command for scheduled PUSCH for DCI format 0_X
Precoding information and number of layers for DCI format 0_X
Phase tracking reference signal (PTRS)-DMRS association for DCI format 0_X
SRS resource indicator for DCI format 0_X

Embodiments of detailed design for Type-2 field for multi-cell scheduling are provided as follows:

In one embodiment, for Type-2 field, field size for DCI format 0_X or 1_X can be determined as maximum size among sum of sub-field size for the active BWP for each cell among all rows of carrier indication table for multi-cell scheduling. Further, each sub-field for the co-scheduled cell is applied based on existing rule for single-cell scheduling. When the actual field size is less than the determined field size for multi-cell scheduling, LSB or MSB of the field is applied. In one example, assuming two rows are configured for the active BWP for carrier indication table for multi-cell scheduling, where first row is configured with {cell #0, cell #1} and second row is configured with {cell #0, cell #2}, and for cell #0 and cell #1, 16 HARQ processes are assumed (i.e., 4 bits) while for cell #2, 32 HARQ processes are assumed (i.e., 5 bits). In this case, the HARQ process number field size for DCI format 0_X and 1_X can be determined as 4+5=9 bits.

In another embodiment, for Type-2 field, field size for DCI format 0_X or 1_X can be determined as maximum size among sum of sub-field size for the active BWP for each cell among all configured cell for multi-cell scheduling. Further, each sub-field for the co-scheduled cell is applied based on existing rule for single-cell scheduling. When the actual field size is less than the determined field size for multi-cell scheduling, LSB or MSB of the field is applied.

In one example, assuming cell #0, cell #1, cell #2 and cell #3 are configured for multi-cell scheduling, for cell #0 and cell #1, 16 HARQ processes are assumed, while for cell #2 and cell #3, 32 HARQ processes are assumed. In this case, the HARQ process number field size for DCI format 0_X and 1_X can be determined as 4+4+5+5=18 bits.

In another embodiment, for Type-2 field, field size for DCI format 0_X or 1_X can be determined as sum of actual sub-field size for the active BWP for each co-scheduled cell for multi-cell scheduling. In this case, DCI format 1_X and 0_X size can be configured by higher layers by RRC signalling or determined in accordance with the maximum size based on all possible field size of co-scheduled cells. Further, carrier indication field is included at the beginning of DCI format 1_X and 0_X. UE first determines the co-scheduled cells in accordance with the carrier indication field and subsequently determines the Type-2 field size in accordance with the determined co-scheduled cells. In some aspects, zero padding is applied when the actual DCI format size is less than the configured or maximum DCI format size.

### Detailed Design for Some DCI Fields

In one embodiment, for FDRA field, when resource allocation type 0 is configured or indicated for resource allocation in frequency, a scaling factor can be applied on the RBG size. In some aspects, the scaling factor can be configured by higher layers via RRC signalling. Further, it may be configured per co-scheduled cell for multi-cell scheduling. Alternatively, a single value of scaling factor can be commonly applied for all co-scheduled cell for multi-cell scheduling.

In one option, the nominal RBG size can be given by:

$$P = K \cdot {P}_{0}$$

Where K is the scaling factor and P₀ may be determined in accordance with the nominal RBG size in Table 5.1.2.2.1-1 in 3GPP TS 38.214. In another option, the following text can be updated to include the scaling factor for the resource allocation type 0.

The total number of RBGs (N_{RBG}) for a downlink bandwidth part i of size
${N}_{BWP , i}^{size} PRBs is given by {N}_{RBG} = ⌈ ( {N}_{BWP , i}^{size} + ( {N}_{BWP , i}^{start} mod ( K \cdot P ) ) ) / ( K \cdot P ) ⌉ ,$
where
- the size of the first RBG is
${RBG}_{0}^{size} = ( K \cdot P ) - {N}_{BWP , i}^{start} mod ( K \cdot P ) ,$
- $the size of last RBG is {RBG}_{last}^{size} = ( {N}_{BWP , i}^{start} + {N}_{BWP , i}^{size} ) mod ( K \cdot P )$
$if ( {N}_{BWP , i}^{start} + {N}_{BWP , i}^{size} ) mod P ( K \cdot P ) > 0 and K \cdot P otherwise ,$
- the size of all other RBGs is K · P.

In one embodiment, for beta offset indicator, a single field can be used to indicate a common information for all co-scheduled cell. In some aspects, when scheduled PUSCH does not overlap with physical uplink control channel (PUCCH) or beta offset indication is semi-statically configured for a cell, the field is not applied. Further, if all configured cells are configured with semi-static beta offset indication, this field is not included in the DCI format 0_X.

When more than one PUSCHs in different co-scheduled cells overlap with PUCCHs, the indicated single beta offset is commonly applied to the PUSCHs associated with the dynamic beta offset indication.

In one embodiment, for CSI request and UL-SCH indicator, a single field can be used to indicate the information for only one of the co-scheduled cells. In particular, only a PUSCH in a cell may be scheduled to carry CSI report in case of multi-cell scheduling.

In addition, the cell where the CSI report is transmitted can be determined as a reference cell. In some aspects, the reference cell can be determined in accordance with one or more of the following rules:
A cell with smallest or largest serving cell index among co-scheduled cells.
A cell that is configured for carrying CSI report for multi-carrier scheduling
A cell that is a scheduling cell.
A cell with smallest subcarrier spacing (SCS)
A cell with earlier or latest starting symbol position for scheduled PUSCH
A cell with smallest or largest MCS

Furthermore, the cell is a cell not overlapping with DL symbols configured by TDD configuration or SSB symbols.

In one embodiment, for A-SRS transmission triggered by DCI format 0_X, in one option, A-SRS transmission without PUSCH is not supported by DCI format 0_X. For example, UE does not expect both CSI request and UL-SCH indicator are set to 0.

In another option, A-SRS transmission without PUSCH on at most one cell can be triggered by DCI format 0_X. For example, both CSI request and UL-SCH indicator are set to 0, and A-SRS request for the reference cell for A-SRS transmission without PUSCH is non-zero. UE transmits A-SRS without PUSCH on the reference cell and UE transmits PUSCH with UL-SCH on other co-scheduled cells with or without A-SRS. The reference cell can be determined in accordance with one or more of the following rules:
A cell with smallest or largest serving cell index among co-scheduled cells.
A cell that is configured for A-SRS transmission without PUSCH for multi-carrier scheduling.
A cell that is a scheduling cell.
A cell with smallest subcarrier spacing (SCS).
A cell with earlier or latest starting symbol position for scheduled PUSCH
A cell with smallest or largest MCS
A same reference cell as determined for CSI request and UL-SCH field.

In one example, if A-CSI request is non-zero, UE does not expect to perform A-SRS only transmission without PUSCH in any of co-scheduled cells.

In another option, A-SRS transmission without PUSCH on multiple cells can be triggered by DCI format 0_X. For example, both CSI request and UL-SCH indicator are set to 0, and A-SRS request for more than one co-scheduled cells are non-zero. UE transmits A-SRS without PUSCH on the cells with non-zero A-SRS request and UE transmits PUSCH with UL-SCH on other co-scheduled cells with zero A-SRS request.

In one embodiment, for UL/SUL indicator, field size in DCI format 0_X can be determined in accordance with number of different SULs configured for a set of cells, which are configured for DCI format 0_X. Alternatively, for UL/SUL indicator, field size in DCI format 0_X can be determined in accordance with number of different SULs configured for a set of cells, which are configured in the carrier indication table for DCI format 0_X.

In one option, when the number of determined cells including UL and SUL in accordance with UL/SUL indicator and carrier indication field is less than the number of co-scheduled cells based on carrier indication field, for Type-2 and Type 1B field, UE determines the corresponding other sub-fields for the determined cells in the order of UL cell index in accordance with the carrier indication field and association between SUL and UL and ignores the remaining sub-fields.

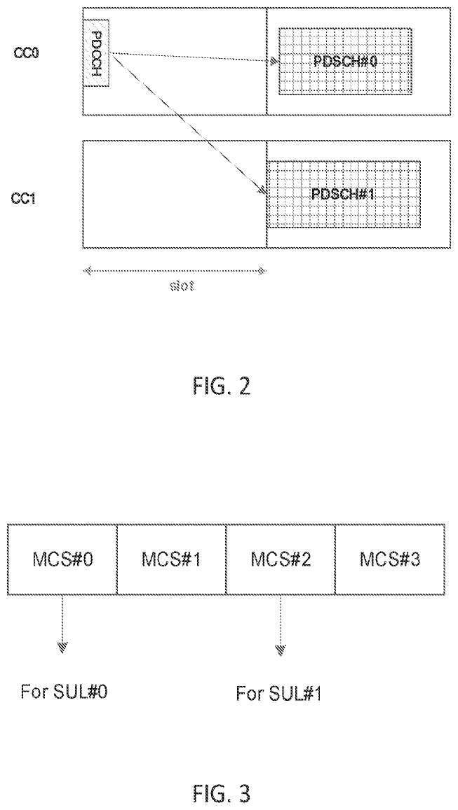

FIG. 3 illustrates one example of Type-2 field determination for UL/SUL operation. In the example, assuming four cells with {cell #0, cell #1, cell #2 and cell #3} are configured for multi-cell scheduling, where {cell #0 and cell #1} are configured with SUL #0, and {cell #2 and cell #3} are configured with SUL #1. In this case, 2 bits UL/SUL indicator can be included in the DCI format 0_X, where first bit is used to indicate whether UL or first SUL is scheduled for PUSCH transmission, while second bit is used to indicate whether UL or second SUL is scheduled for PUSCH transmission.

Further, assuming all four cells are scheduled based on carrier indication field, and “11” is indicated based on UL/SUL field, which indicate that two SULs are actually scheduled. In this case, for all Type-2 field in the DCI format 0_X, UE determines the sub-field for these two SUL in based on the corresponding normal UL index. In the figure, MCS #0 is indicated for SUL #0 while MCS #2 is indicated for SUL #1.

In one option, when the number of determined cells including UL and SUL in accordance with UL/SUL indicator and carrier indication field is less than the number of co-scheduled cells based on carrier indication field, for Type-2 and Type 1B field, UE determines the corresponding sub-fields for the determined cells in the order of UL cell index in accordance with the SUL index and ignores the remaining sub-fields.

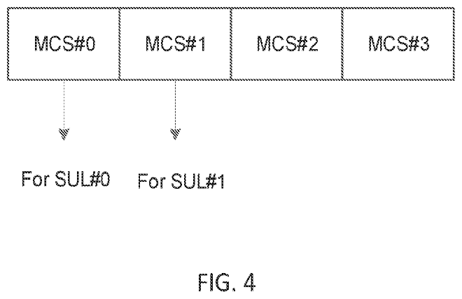

FIG. 4 illustrates one example of Type-2 field determination for UL/SUL operation. In the example, assuming four cells with {cell #0, cell #1, cell #2 and cell #3} are configured for multi-cell scheduling, where {cell #0 and cell #1} are configured with SUL #0, and {cell #2 and cell #3} are configured with SUL #1. In this case, 2 bits UL/SUL indicator can be included in the DCI format 0_X, where first bit is used to indicate whether UL or first SUL is scheduled for PUSCH transmission, while second bit is used to indicate whether UL or second SUL is scheduled for PUSCH transmission.

Further, assuming all four cells are scheduled based on carrier indication field, and “11” is indicated based on UL/SUL field, which indicate that two SULs are actually scheduled. In this case, for all Type-2 field in the DCI format 0_X, UE determines the sub-field for these two SULs in based on the corresponding SUL index. In the figure, MCS #0 is indicated for SUL #0 while MCS #1 is indicated for SUL #1.

In another option, UE does not expect that the number of determined cells including UL and SUL in accordance with UL/SUL indicator and carrier indication field to be different from the number of actually co-scheduled cells based on carrier indication field. In another option, UE does not expect that more than one co-scheduled cell are associated with a same SUL.

In one example, assuming four cells with {cell #0, cell #1, cell #2 and cell #3} are configured for multi-cell scheduling, where all four cells are configured with SUL #0. In this case, 1 bits UL/SUL indicator can be included in the DCI format 0_X, which is used to indicate whether UL or SUL is scheduled for PUSCH transmission.

In another embodiment, for UL/SUL indicator, field size in DCI format 0_X can be determined in accordance with the number of actually co-scheduled cells, which is determined in accordance with the carrier indication field in the DCI format 0_X.

In another option, for UL/SUL indicator, field size in DCI format 0_X can be determined in accordance with the maximum number of co-scheduled cells, which is determined in accordance with the carrier indication table configured for the DCI format 0_X. Alternatively, field size for UL/SUL indicator can be fixed to four.

In another option, for UL/SUL indicator, field size in DCI format 0_X can be determined in accordance with the maximum number of co-scheduled cells that are associated with a SUL, which is determined in accordance with the carrier indication table configured for the DCI format 0_X.

In one example, assuming four cells with {cell #0, cell #1, cell #2 and cell #3} are configured for multi-cell scheduling, where {cell #0 and cell #1} are configured with SUL #0, and {cell #2 and cell #3} are configured with SUL #1. Further, all four cells are scheduled based on carrier indication field, and “1010” is indicated based on UL/SUL field. In this case, SUL #0, cell #1, SUL #1, cell #3 are scheduled based on the UL-SUL indication.

In one embodiment, when carrier indication table is not configured for multi-cell scheduling, the UE determines the actually scheduled cell(s) based on the FDRA field of each cell of the set of cells. Further, for Type 0 FDRA, all 0s indicates the cell is not scheduled and for Type 1 FDRA, all 1s indicates the cell is not scheduled. In one option, when dynamic switch for resource allocation is configured in an active BWP in a cell, all 1s indicates that the cell is not scheduled. In another option, when dynamic switch for resource allocation is configured in an active BWP in a cell, all 0s indicates that the cell is not scheduled. In another option, when dynamic switch for resource allocation is configured in an active BWP in a cell, to indicate the cell is not scheduled, all bits of the FDRA filed are equal to 0 or 1.

In one embodiment, if minimum applicable scheduling offset indicator field is configured for DCI format 0_X and/or 1_X, the minimum applicable scheduling offset indicator field can be viewed as Type 1A field and is commonly applied for the active BWPs for all the co-scheduled or configured cells which are configured with minimumSchedulingOffsetK0 or minimumSchedulingOffsetK2 for DCI format 1_1 or DCI format 0_1, respectively. When the active BWP in a co-scheduled cell is not configured with minimumSchedulingOffsetK0 or minimumSchedulingOffsetK2, the minimum applicable scheduling offset indicator field is not applied.

In one embodiment, for DCI format 0_X and/or 1_X, the DCI fields for the PCell and/or one or more SCells can be repurposed to switch the dormancy behavior of the SCells. In Rel-16, if one-shot HARQ-ACK request is not present or set to ‘0’, and all bits of frequency domain resource assignment are set to 0 for resource allocation type 0 or set to 1 for resource allocation type 1 or set to 0 or 1 for dynamic switch resource allocation type, the following fields among the fields above are used for SCell dormancy indication, where each bit corresponds to one of the configured SCell(s), with MSB to LSB of the following fields concatenated in the order below corresponding to the SCell with lowest to highest SCell index
Modulation and coding scheme of transport block 1
New data indicator of transport block 1
Redundancy version of transport block 1
HARQ process number
Antenna port(s)
DMRS sequence initialization

However, for a DCI format for multi-cell scheduling, the ‘antenna port(s)’ and ‘DMRS sequence initialization’ files may not be available for SCell dormancy indication. Further, the size of ‘Redundancy version of transport block 1’ and ‘HARQ process number’ fields is configurable. In consequence, the bits available for repurposing for PCell can be less than 15 bits.

In a first option, a DCI format for multi-cell scheduling which indicates SCell dormancy behavior by repurposing the DCI fields for PCell cannot schedule PDSCH or PUSCH on any SCell. In this scheme, the DCI fields of PCell to be repurpose for SCell dormancy indication can be same as existing specification. In a second option, a DCI format for multi-cell scheduling which indicates SCell dormancy behavior by repurposing the DCI fields for PCell can schedule PDSCH or PUSCH on a SCell. In a third option, a DCI format for multi-cell scheduling which indicates SCell dormancy behavior by repurposing the DCI fields for PCell must schedule PDSCH or PUSCH on at least one SCell.

In the second or third option, UE can expect that the number of repurposed bits is not less than the number of SCells. Alternatively, if the number of repurposed bits is less than the number of SCells, only a subset of the SCells, e.g. the SCells with low indexes can switch the dormancy behavior by the DCI format. Alternatively, the SCells e.g., the SCell with lowest indexes that are not scheduled with a PDSCH or PUSCH by the DCI format can be indicated to switch the dormancy behavior by the repurposed bits. For example, if the DCI format schedules PDSCHs on the three SCells, the repurposed bits for SCell dormancy indication apply to the SCells other than the three scheduled SCells by DCI format. The UE can expect that the number of repurposed bits is not less than the number of SCells except for the SCells that are scheduled with PDSCH or PUSCH by the DCI format.

In a fourth option, a DCI format for multi-cell scheduling which indicates SCell dormancy behavior by repurposing the DCI fields for PCell and SCell can schedule PDSCH or PUSCH on a SCell. In a fifth option, a DCI format for multi-cell scheduling which indicates SCell dormancy behavior by repurposing the DCI fields for PCell and SCell must schedule PDSCH or PUSCH on at least one SCell. In the fourth or fifth option, gNB will not schedule PDSCH or PUSCH to PCell and the SCell when the DCI fields for the SCell are reused for SCell dormancy indication. For both PCell and the SCell, all bits of FDRA filed are set to 0 for resource allocation type 0 or set to 1 for resource allocation type 1 or set to 0 or 1 for dynamic switch resource allocation type. Alternatively, the FDRA of PCell is set to all 0s or all 1s, which indicates that the DCI can indication SCell dormancy behavior. Correspondingly, the SCell with DCI fields repurposed for SCell dormancy indication can be indicated by the ‘carrier indication’ field. For example, the SCell can be a SCell that is not scheduled a PDSCH or PUSCH as indicated by the ‘carrier indication’ field. In this case, the FDRA field of the SCell is neglected or the FDRA field of the SCell is still set to all 0s or all 1s. If there are multiple SCells that are indicated with FDRA of all 0s or all 1s or indicated as not scheduled by the ‘carrier indication’ field, DCI fields of one SCell, e.g., the SCell with lowest index are used for SCell dormancy indication. In the fourth option, gNB can still schedule PDSCH or PUSCH to a SCell if the DCI fields for the SCell are not reused for SCell dormancy indication. In the fifth option, gNB must schedule PDSCH or PUSCH to at least one SCell and the DCI fields for the SCell are not reused for SCell dormancy indication.

In a sixth option, a DCI format for multi-cell scheduling which indicates SCell dormancy behavior by repurposing the DCI fields for PCell or a reference SCell can schedule PDSCH or PUSCH on a cell. The cell may be a PCell or a SCell if the DCI fields of the cell is not repurposed for SCell dormancy indication. The reference SCell can be configured by high layer signaling or determined by a rule, e.g., the SCell with lowest cell index. In this option, if the FDRA field for PCell is set to all 0s or all Is which indicates that the DCI indicates SCell dormancy behavior, the reference SCell may be scheduled with a PDSCH or PUSCH transmission. In this case, the DCI fields for PCell can be repurposed for SCell dormancy switching. Otherwise, if the PCell is scheduled with a PDSCH or PUSCH transmission by the DCI format, whether the DCI format is triggering SCell dormancy switching is indicated by the FDRA field of the reference SCell. Specifically, the FDRA field for reference SCell can be set to all 0s or all 1s to indicate that the DCI indicates SCell dormancy behavior. In this case, the DCI fields for the reference SCell can be repurposed for SCell dormancy switching.

In a seventh option, a DCI format for multi-cell scheduling which indicates SCell dormancy behavior by repurposing the DCI fields for one or more reference SCells can schedule PDSCH or PUSCH on a cell. The cell may be the PCell, or a SCell if the DCI fields of the SCell is not repurposed for SCell dormancy indication. The reference SCells can be configured by high layer signaling or determined by a rule, e.g., the SCell with lowest cell indexes. The FDRA field for the reference SCells are set to all 0s or all Is to indicate that the DCI indicates SCell dormancy behavior.

In the above second to seventh options, if ‘Antenna port(s)’ field in the DCI format is separately indicated for each cell, the following DCI fields for PCell or the reference SCell can be repurposed for SCell dormancy indication
Modulation and coding scheme of transport block 1
New data indicator of transport block 1
Redundancy version of transport block 1
HARQ process number
Antenna port(s)

On the other hand, if ‘Antenna port(s)’ field in the DCI format is applicable to all cells, the following DCI fields for PCell or the reference SCell can be repurposed for SCell dormancy indication
Modulation and coding scheme of transport block 1
New data indicator of transport block 1
Redundancy version of transport block 1
HARQ process number

Alternatively, in the above second to seventh options, only the following fields for PCell or the reference Scell can be repurposed for SCell dormancy indication
Modulation and coding scheme of transport block 1
New data indicator of transport block 1
Redundancy version of transport block 1
HARQ process number

In the above second to seventh options, if the DCI format for multi-cell scheduling is indicating SCell dormancy switching, the gNB may schedule a PDSCH or PUSCH to a SCell only when the dormancy state for the SCell is not changed by the DCI format. For a SCell for dormancy state switching, the FDRA field of the SCell is neglected or the FDRA field of the SCell is still set to all 0s or all 1s.

In one embodiment, for DCI format 0_X and/or 1_X, if PCell is not one of the configured cells that can be scheduled by the DCI format 0_X and/or 1_X, the DCI fields for a reference SCell can be repurposed to switch the dormancy behavior of the SCells. The reference SCell can be configured by high layer signaling or determined by a rule, e.g., the SCell with lowest cell index. Alternatively, the DCI fields for one or more reference SCells can be repurposed to switch the dormancy behavior of the SCells. The reference SCells can be configured by high layer signaling or determined by a rule, e.g., the SCell with lowest cell indexes.

In a first option, a DCI format for multi-cell scheduling which indicates SCell dormancy behavior by repurposing the DCI fields for the reference SCell(s) cannot schedule PDSCH or PUSCH on any SCell. In a second option, a DCI format for multi-cell scheduling which indicates SCell dormancy behavior by repurposing the DCI fields for the reference SCell(s) can schedule PDSCH or PUSCH on a SCell. In a third option, a DCI format for multi-cell scheduling which indicates SCell dormancy behavior by repurposing the DCI fields for the reference SCell(s) must schedule PDSCH or PUSCH on at least one SCell.

In the above three options, if the DCI format for multi-cell scheduling is indicating SCell dormancy switching, the gNB may schedule a PDSCH or PUSCH to a SCell only when the dormancy state for the SCell is not changed by the DCI format. For a SCell for dormancy state switching, the FDRA field of the SCell is neglected or the FDRA field of the SCell is still set to all 0s or all 1s.

As a further extension, for DCI format 0_X and/or 1_X, when PDSCH and/or PUSCH in PCell and/or Scell are scheduled by the DCI format, respectively, and when SCell dormancy indication is presented in the DCI format, UE does not expect that the SCells that are scheduled with PDSCH and/or PUSCH are indicated with Scell dormancy by SCell dormancy indication.

In one embodiment, if the Transmission configuration indication field is configured for DCI format 1_X, the bit field is Type 1B with a joint indication, which points to a row of a table configured by RRC signalling for multi-cell scheduling. Each element in the row is linked to the corresponding codepoint of TCI applicable for DCI format 1_1 for corresponding cell respectively. In one option, for one scheduled cell, the indicated codepoint of TCI can only be associated with one TCI state. That is, a UE does not expect to be indicated a codepoint of TCI indication in DCI format 1_X to associate with more than one TCI states. In another option, for one scheduled cell, if more than one TCI states are associated with a codepoint of TCI indication in DCI format 1_X, the first TCI state or the TCI state with lowest index is applied for the PDSCH scheduled by DCI format 1_X.

Some embodiments are directed to a User Equipment (UE) configured for operation in a fifth-generation new radio (5G NR) network. In these embodiments, the UE may encode radio-resource control (RRC) signalling for transmission to a gNodeB (gNB). The RRC signalling may be encoded to indicate a UE capability for multi-cell scheduling. In these embodiments, the UE may decode a downlink control information (DCI) format for multi-cell scheduling. The DCI format may schedule at least one physical downlink shared channel (PDSCH) or at least one physical uplink shared channel (PUSCH) over multiple cells. In these embodiments, at least one PDSCH or at least one PUSCH that is scheduled by the DCI format is scheduled in more than one cell of a set of cells, each cell corresponding to a component carrier (CC). In these embodiments, DCI format for multi-cell scheduling may comprise a Type-1 field and a Type-2 field. In these embodiments, the Type-1 field may be a single field comprising only one of a Type-1A field, a Type-1B field, and a Type-1C field. In these embodiments, when the Type-1 field comprises the Type-1A field, the Type-1A field indicates common information for all of the multiple cells within the set that are co-scheduled by the DCI format. In these embodiments, when the Type-1 field comprises the Type-1B field, the Type-1B field indicates separate information jointly indicated for each of the multiple cells within the set that are co-scheduled by the DCI format. In these embodiments, when the Type-1 field comprises the Type-1C field, the Type-1C field indicates information for only one of the multiple cells within the set that are co-scheduled by the DCI format. In these embodiments, the Type-2 field comprises a plurality of separate fields, each of the separate fields of the Type-2 field indicating information for one of the multiple cells of the set that that are co-scheduled by the DCI format.

In these embodiments, since only one of a Type-1A field, a Type-1B field, and a Type-1C field is included in the DCI format, a reduction in DCI payload may be achieved. For example, a Type-1A field indicates common information for all co-scheduled cells and requires fewer bits compared to the Type-2 field which includes a separate field for each of the co-scheduled cells. For example, the Type-1B field, may include a pointer to a table and may comprise a single bit. For example, the Type-1C field indicates information for only one of the co-scheduled. These embodiments are discussed in more detail below.

In some embodiments, the DCI format for multi-cell scheduling schedules more than one PDSCH or more than one PUSCH over the multiple cells. In these embodiments, the DCI format for multi-cell scheduling comprises a DCI format 0_3 for scheduling the PUSCHs in the multiple cells. In these embodiments, the DCI format for multi-cell scheduling comprises a DCI format 1_3 for scheduling the PDSCHs in the multiple cells. In these embodiments, the DCI format for multi-cell scheduling is a single DCI format. In these embodiments, a single DCI format may be used to schedule more than one PDSCH or more than one PUSCH over multiple cells.

In some embodiments, a size of the Type-1A field in the DCI format is determined as maximum field size of active bandwidth parts (BWPs) among all cells within the set of cells. In these embodiments, a size of the Type-1B field in the DCI format is determined based on a number of rows in an RRC-configured table for the DCI format for multi-cell scheduling. In these embodiments, a size of the Type-2 field in the DCI format is determined based on an active BWP for each cell in the set. In these embodiments, since the UE is able to determine the size of these fields of the DCI format, the UE does not need to perform blind decoding on the DCI format.

In some embodiments, the Type-1B field in the DCI format indicates (e.g., points to) one row in the RRC-configured table and the size of the Type-1B field is equal to ceiling (log 2(N)). In these embodiments, N is a number of rows in the RRC-configured table for the DCI format for multi-cell scheduling. In these embodiments, each row has multiple indices, each of the multiple indices indicate one of the cells of the set, and each of the multiple indices point to a corresponding index in an RRC-configured table for either a DCI format 0_1 or a DCI format 1_1. In these embodiments, the number of rows N in the RRC-configured table for the DCI format for multi-cell scheduling is a whole number less than 100. In these embodiments, only one bit may be needed for the Type-1B field since this field is a pointer to an RRC-configured table, thus allowing for a reduction in size of the DCI format payload.

In some embodiments, the DCI format for multi-cell scheduling further includes a beta-offset indicator field of two bits when the cells are the set are configured with a dynamic beta offset, the beta-offset indicator field not included (i.e., beta-offset indicator field is zero bits) in the DCI format for multi-cell scheduling when all cells of the set are configured with a semi-static beta offset. In these embodiments, the beta offset is used by the UE for determining amount of the resource for UCI on PUSCH for transmissions to and from the gNB.

In some embodiments, the Type-1C field comprises a channel-state information (CSI) request field and uplink scheduling (UL-SCH) indicator field. In these embodiments, the processing circuitry is configured to apply the CSI request field and the UL-SCH indicator field to a cell of the set having a smallest service cell index indicated by a scheduled cells indicator field or a frequency domain resource assignment (FDRA) field. In some embodiments, the UE may encode a CSI report for transmission on a PUSCH of the cell having the smallest service cell index. In these embodiments, the cell is a co-scheduled cell that is within the set of cells that are co-scheduled by the DCI format for multi-cell scheduling having the smallest cell index.

In some embodiments, for a cell having a smallest service cell index among cells of the set of cells that are not scheduled by the DCI format for multi-cell scheduling, when a field for requesting one-shot HARQ-ACK is not present in the DCI format for multi-cell scheduling, one or more of other fields indicate (i.e., repurposed) secondary cell (SCell) dormancy, the one or more other fields including a modulation and coding scheme of transport block 1 field, a new data indicator of transport block 1 field, a redundancy version of transport block 1 field, a HARQ process number field, and an antenna ports field.

In some embodiments, the DCI format for multi-cell scheduling further includes an frequency domain resource assignment (FDRA) field. In these embodiments, to indicate dynamic switching for resource allocation type for a cell within the set of cells that are co-scheduled by the DCI format for multi-cell scheduling, all bits of the FDRA field are set to a same value. The same value may be either all zeros or all ones. In these embodiments, if the higher layer parameter ScheduledCellCombo-ListDCI-0-3 for the scheduled cell set is not configured, each block is also used to indicate whether the corresponding cell is scheduled or not scheduled for dynamic switch resource allocation type. In these embodiments, if all bits of a block are set to 0 for resource allocation type 0, or set to 1 for resource allocation type 1, or set to 0 or 1 for dynamic switch resource allocation type, or set to 0 for resource allocation Type-2 with μ=1, or set to 1 for resource allocation Type-2 with μ=0, the cell corresponding to the block is not scheduled.

In some embodiments, the multiple cells scheduled by the DCI format for multi-cell scheduling comprise two or more cells that are co-scheduled including up to one or more intra-band cells and up to one or more inter-band cells. In these embodiments, the multiple cells that are scheduled by the DCI format for multi-cell scheduling may comprise one cell for fallback operations, although the scope of the embodiments are not limited in this respect.

Some embodiments are directed to a non-transitory computer-readable storage medium that stores instructions for execution by processing circuitry of a User Equipment (UE) configured for operation in a fifth-generation new radio (5G NR) network. In these embodiments, the processing circuitry may encode radio-resource control (RRC) signalling for transmission to a gNodeB (gNB), the RRC signalling encoded to indicate a UE capability for multi-cell scheduling. In these embodiments, the processing circuitry may decode a downlink control information (DCI) format for multi-cell scheduling. In these embodiments, the DCI format may schedule at least one physical downlink shared channel (PDSCH) or at least one physical uplink shared channel (PUSCH) over multiple cells. In these embodiments, the at least one PDSCH or the at least one PUSCH that is scheduled by the DCI format is scheduled in more than one cell of a set of cells, each cell corresponding to a component carrier (CC). In these embodiments, DCI format for multi-cell scheduling comprises a Type-1 field and a Type-2 field. The Type-1 field may be a single field comprising only one of a Type-1A field, a Type-1B field, and a Type-1C field. In these embodiments, when the Type-1 field comprises the Type-1A field, the Type-1A field indicates common information for all of the multiple cells within the set that are co-scheduled by the DCI format. In these embodiments, when the Type-1 field comprises the Type-1B field, the Type-1B field indicates separate information jointly indicated for each of the multiple cells within the set that are co-scheduled by the DCI format. In these embodiments, when the Type-1 field comprises the Type-1C field, the Type-1C field indicates information for only one of the multiple cells within the set that are co-scheduled by the DCI format. In these embodiments, the Type-2 field comprises a plurality of separate fields, each of the separate fields of the Type-2 field indicating information for one of the multiple cells of the set that that are co-scheduled by the DCI format.

Some embodiments are directed to a gNodeB (gNB) configured for operation in a fifth-generation new radio (5G NR) network. In these embodiments, the gNB may decode radio-resource control (RRC) signalling received from a User Equipment (UE). The RRC signalling may indicate a UE capability for multi-cell scheduling. The gNB may also encode a downlink control information (DCI) format for transmission to the UE for multi-cell scheduling. In these embodiments, the DCI format may schedule at least one physical downlink shared channel (PDSCH) or at least one physical uplink shared channel (PUSCH) over multiple cells. In these embodiments, the at least one PDSCH or the at least one PUSCH that is scheduled by the DCI format is scheduled in more than one cell of a set of cells. In these embodiments, each cell corresponds to a component carrier (CC). In these embodiments, DCI format for multi-cell scheduling may comprise a Type-1 field and a Type-2 field. In these embodiments, the Type-1 field may be a single field comprising only one of a Type-1A field, a Type-1B field, and a Type-1C field. In these embodiments, when the Type-1 field comprises the Type-1A field, the Type-1A field indicates common information for all of the multiple cells within the set that are co-scheduled by the DCI format. In these embodiments, when the Type-1 field comprises the Type-1B field, the Type-1B field indicates separate information jointly indicated for each of the multiple cells within the set that are co-scheduled by the DCI format. In these embodiments, when the Type-1 field comprises the Type-1C field, the Type-1C field indicates information for only one of the multiple cells within the set that are co-scheduled by the DCI format. In these embodiments, the Type-2 field comprises a plurality of separate fields and each of the separate fields of the Type-2 field may indicate information for one of the multiple cells of the set that that are co-scheduled by the DCI format.

In some embodiments, the Types for the following fields for DCI format 0_3 are shown in the table below:

| Field | Type |
|---|---|
| HARQ process | Type-2 |
| number | |
| MCS | Alt 1: Type-2 (without compression) |
| BWP indicator | Type 1A |
| FDRA | Type-2 |
| | Further consider larger RBG |
| | granularity than existing maximum |
| | specified or configured value for RA |
| | type 0 |
| | Use large RBG-based RIV for RA |
| | type 1 based on R16 configurable |
| | granularities for DCI format 1_2 |
| Frequency hopping | Type 1A |
| flag | |
| TPC command for | Type-2 |
| scheduled PUSCH | |
| Open-loop power | Type 1A |
| control parameter set | |
| indication | |
| Antenna port(s) | Configurable between Type 1A and |
| | Type-2 |
| Precoding | Configurable between Type 1A and |
| information and | Type-2 |
| number of layers | |
| PTRS-DMRS | Type-2 |
| association | |
| DMRS sequence | Type 1A |
| initialization | |
| SRS request | Type 1B (up to 4 bits) |
| SRS resource | Configurable between Type 1A and |
| indicator | Type-2 |
| SRS offset indicator | Type 1B (up to 3 bits) |
| UL/SUL indicator | FFS |

In some embodiments, the Types for the following fields for DCI format 1_3 are shown in the table below:

| Field | Type |
|---|---|
| HARQ process | Type-2 |
| number | |
| MCS | Alt 1: Type-2 (without compression) |
| BWP indicator | Type 1A |
| FDRA | Type-2 |
| | Further consider larger RBG |
| | granularity than existing maximum |
| | specified or configured value for RA |
| | type 0 |
| | Use large RBG-based RIV for RA |
| | type 1 based on R16 configurable |
| | granularities for DCI format 1_2 |
| VRB-to-PRB | Type 1A |
| mapping | |
| PRB bundling size | Type 1A |
| indicator | |
| Rate matching | Type 1B (up to 4 bits) |
| indicator | |
| ZP CSI-RS trigger | Type 1B (up to 3 bits) |
| Antenna port(s) | Configurable between Type 1A and |
| | Type-2 |
| TCI | Type 1B (up to 4 bits) |
| DMRS sequence | Type 1A |
| initialization | |
| SRS request | Type 1B (up to 4 bits) |
| SRS offset indicator | Type 1B (up to 3 bits) |

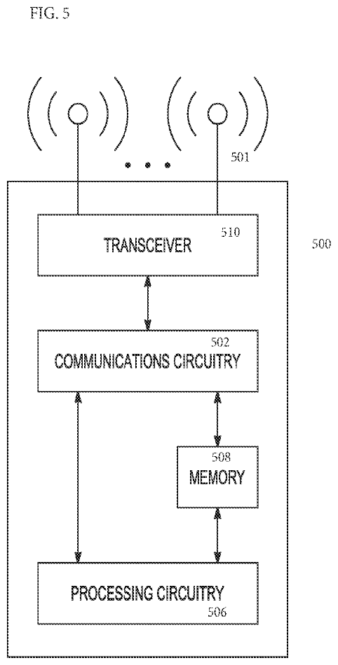

FIG. 5 illustrates a functional block diagram of a wireless communication device, in accordance with some embodiments. Wireless communication device 500 may be suitable for use as a UE or gNB configured for operation in a 5G NR or 6G network. The wireless communication device 500 may include communications circuitry 502 and a transceiver 510 for transmitting and receiving signals to and from other communication devices using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The wireless communication device 500 may also include processing circuitry 506 and memory 508 arranged to perform the operations described herein. In some embodiments, the communications circuitry 502 and the processing circuitry 506 may be configured to perform operations detailed in the above figures, diagrams, and flows.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the wireless communication device 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the wireless communication device 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 500 may include one or more of a keyboard, a display, a non-volatile memory port, multiple antennas, a graphics processor, an application processor, speakers, and other mobile device elements. The display may be an LCD screen including a touch screen.

Although the wireless communication device 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 500 may refer to one or more processes operating on one or more processing elements.

### EXAMPLES

Example 1. A system and method of wireless communication for a fifth generation (5G) or new radio (NR) system, comprising: decoded, by UE, a downlink control information (DCI) that is used schedule physical uplink shared channel (PUSCH) or physical downlink shared channel (PDSCH) in more than one cell.

Example 2. The method of example 1, wherein for Type 1A field, field size in DCI format 0_X and/or 1_X can be determined as maximum field size for each cell from configured carrier indication table for multi-cell scheduling.

Example 3. The method of example 1, wherein if the field size determined for a co-scheduled cell is 0, the field in the DCI format 0_X and/or 1_X is not applied; wherein if the field size for a co-scheduled cell is less than the determined field size in the DCI format 0_X and/or 1_X, least significant bit (LSB) or most significant bit (MSB) of the field is applied.

Example 4. The method of example 1, wherein for Type 1A field, field size in DCI format 0_X and/or 1_X can be determined as maximum field size for each cell from number of cells configured for multi-cell scheduling or maximum number of cells for multi-cell scheduling (i.e., 4).

Example 5. The method of example 1, wherein for Type 1B field, a joint indication is applied, which points to a row of a table configured by RRC signalling for multi-cell scheduling.

Example 6. The method of example 5, wherein each row includes M sub-fields, where M is number of actually co-scheduled cells for multi-cell scheduling associated with non-zero bit length for the corresponding bit field, which is determined based on carrier indication field in the DCI format 0_X and 1_X.

Example 7. The method of example 5, wherein each row includes N sub-fields, where N is number of cells configured for multi-cell scheduling associated with non-zero bit length for the corresponding bit field.

Example 8. The method of example 1, wherein for Type-2 field, field size for DCI format 0_X or 1_X can be determined as maximum size among sum of sub-field size for each cell among all rows of carrier indication table for multi-cell scheduling.

Example 9. The method of example 8, wherein each sub-field for the co-scheduled cell is applied based on existing rule for single-cell scheduling.

Example 10. The method of example 1, wherein for Type-2 field, field size for DCI format 0_X or 1_X can be determined as maximum size among sum of sub-field size for each cell among all configured cell for multi-cell scheduling.

Example 11. The method of example 1, wherein for Type-2 field, field size for DCI format 0_X or 1_X can be determined as sum of actual sub-field size for each co-scheduled cell for multi-cell scheduling.

Example 12. The method of example 1, wherein for FDRA field, when resource allocation type 0 is configured or indicated for resource allocation in frequency, a scaling factor can be applied on the RBG size.

Example 13. The method of example 1, wherein for beta offset indicator, a single field can be used to indicate a common information for all co-scheduled cell.

Example 14. The method of example 1, wherein when scheduled PUSCH does not overlap with physical uplink control channel (PUCCH) or beta offset indication is semi-statically configured for a cell, the field is not applied; wherein if all configured cells are configured with semi-static beta offset indication, this field is not included in the DCI format 0_X.

Example 15. The method of example 1, wherein for CSI request and UL-SCH indicator, a single field can be used to indicate the information for only one of the co-scheduled cells.

Example 16. The method of example 1, wherein the cell where the CSI report is transmitted can be determined as a reference cell.

Example 17. The method of example 1, wherein for A-SRS transmission triggered by DCI format 0_X, in one option, A-SRS transmission without PUSCH is not supported by DCI format 0_X.

Example 18. The method of example 1, wherein A-SRS transmission without PUSCH on at most one cell can be triggered by DCI format 0_X.

Example 19. The method of example 1, wherein for UL/SUL indicator, field size in DCI format 0_X can be determined in accordance with number of different SULs configured for a set of cells, which are configured for DCI format 0_X.

Example 20. The method of example 19, wherein when the number of determined cells including UL and SUL in accordance with UL/SUL indicator and carrier indication field is less than the number of co-scheduled cells based on carrier indication field, for Type-2 and Type 1B field, UE determines the corresponding other sub-fields for the determined cells in the order of UL cell index in accordance with the carrier indication field and association between SUL and UL and ignores the remaining sub-fields.

Example 21. The method of example 19, wherein when the number of determined cells including UL and SUL in accordance with UL/SUL indicator and carrier indication field is less than the number of co-scheduled cells based on carrier indication field, for Type-2 and Type 1B field, UE determines the corresponding sub-fields for the determined cells in the order of UL cell index in accordance with the SUL index and ignores the remaining sub-fields.

Example 22. The method of example 1, wherein for UL/SUL indicator, field size in DCI format 0_X can be determined in accordance with the number of actually co-scheduled cells, which is determined in accordance with the carrier indication field in the DCI format 0_X.

Example 23. The method of example 1, wherein field size in DCI format 0_X can be determined in accordance with the maximum number of co-scheduled cells, which is determined in accordance with the carrier indication table configured for the DCI format 0_X.

Example 24. The method of example 1, wherein field size in DCI format 0_X can be determined in accordance with the maximum number of co-scheduled cells that are associated with a SUL, which is determined in accordance with the carrier indication table configured for the DCI format 0_X

Example 25. The method of example 1, wherein the minimum applicable scheduling offset indicator field is commonly applied for the active BWPs for all the co-scheduled cells which are configured with minimumSchedulingOffsetK0 or minimumSchedulingOffsetK2 for DCI format 1_1 or DCI format 0_1, respectively.

Example 26. The method of example 1, wherein for DCI format 0_X and/or 1_X, the DCI fields for the PCell and/or one or more SCells are repurposed to switch the dormancy behavior of the SCells.

Example 27. The method of example 1, wherein for DCI format 0_X and/or 1_X, if PCell is not one of the configured cells that is scheduled by the DCI format 0_X and/or 1_X, the DCI fields for a reference SCell are repurposed to switch the dormancy behavior of the Scells.

Example 28. The method of example 1, wherein for one scheduled cell, if more than one TCI states are associated with a codepoint of TCI indication in DCI format 1_X, the first TCI state or the TCI state with lowest index is applied for the PDSCH scheduled by DCI format 1_X.

The Abstract is provided to comply with 37 C.F.R. Section 1.72 (b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus for a User Equipment (UE) configured for operation in a fifth-generation new radio (5G NR) network, the apparatus comprising: processing circuitry; and memory, wherein the processing circuitry is configured to:
decode a downlink control information (DCI) format, the DCI format scheduling multiple physical uplink shared channels (PUSCHs) in multiple cells with one PUSCH per cell, the multiple cells comprising a set of scheduled cells,
the DCI format comprising at least an uplink shared channel (UL-SCH) indicator field, and a channel-state information (CSI) request field,
the DCI format further comprising a beta-offset indicator when the cells of the set are configured for a dynamic beta offset,
wherein the processing circuitry is further configured to:
apply the CSI request field and the UL-SCH indicator field to a cell of the set having a smallest service cell index;
encode a CSI report for transmission in a PUSCH of the cell having the smallest service cell index in accordance with the CSI request field;
encode an UL-SCH for transmission in the PUSCH of the cell having the smallest service cell index when indicated by the UL-SCH indicator field; and
apply a beta offset value indicated by the beta-offset indicator to the transmissions in the PUSCH when the cells of the set are configured for the dynamic beta offset.

2. The apparatus of claim 1, wherein when the cells of the set are configured for the dynamic beta offset, the processing circuitry is configured to dynamically apply the beta offset value indicated by the DCI format to transmissions in the PUSCH of the cell having the smallest service cell index.

3. The apparatus of claim 2, wherein when the DCI format does not include the beta-offset indicator, the cells of the set are configured for semi-static beta offset and the processing circuitry is configured to apply a beta offset value configured by higher-layer signalling to transmissions in the PUSCH of the cell having the smallest service cell index.

4. The apparatus of claim 3, wherein the processing circuitry is configured to determine an amount of resources for the transmissions in the PUSCH based on a beta offset value.

5. The apparatus of claim 3, wherein at least one of the CSI request field and the UL-SCH field has at least one bit with a value of one, wherein the UE is not expected to receive a DCI format with UL-SCH indicator of zero and CSI request of all zeros.

6. The apparatus of claim 5, wherein at least one of the CSI request field and the UL-SCH field have a non-zero value, and
wherein when all bits of the CSI request field are zero, no CSI report is requested.

7. The apparatus of claim 3, wherein the DCI format further includes configurable Type-1A fields.

8. The apparatus of claim 3, wherein when an frequency domain resource assignment (FDRA) field of the DCI format indicates that dynamic switch for resource allocation is configured for an active bandwidth part of a cell of the set, the processing circuitry is configured to determine that the cell is scheduled when either all bits of the FDRA field are not set to zero or when all bits of the FDRA field are not set to one.

9. The apparatus of claim 8, wherein the processing circuitry is configured to apply the CSI request field and the UL-SCH indicator field to the cell of the set having a smallest service cell index indicated by the FDRA field of the DCI format.

10. The apparatus of claim 3, wherein the DCI format is DCI format 0_3, and
wherein the processing circuitry is configured to encode radio-resource control (RRC) signalling for transmission to a gNodeB (gNB), the RRC signalling encoded to indicate a UE capability for multi-cell PUSCH scheduling.

11. A computer-readable storage medium that stores instructions for execution by processing circuitry of a User Equipment (UE) configured for operation in a fifth-generation new radio (5G NR) network, wherein the processing circuitry is configured to:
decode a downlink control information (DCI) format, the DCI format scheduling multiple physical uplink shared channels (PUSCHs) in multiple cells with one PUSCH per cell, the multiple cells comprising a set of scheduled cells,
the DCI format comprising at least an uplink shared channel (UL-SCH) indicator field, and a channel-state information (CSI) request field,
the DCI format further comprising a beta-offset indicator when the cells of the set are configured for a dynamic beta offset,
wherein the processing circuitry is further configured to:
apply the CSI request field and the UL-SCH indicator field to a cell of the set having a smallest service cell index;
encode a CSI report for transmission in a PUSCH of the cell having the smallest service cell index in accordance with the CSI request field;
encode an UL-SCH for transmission in the PUSCH of the cell having the smallest service cell index when indicated by the UL-SCH indicator field; and
apply a beta offset value indicated by the beta-offset indicator to the transmissions in the PUSCH when the cells of the set are configured for the dynamic beta offset.

12. The computer-readable storage medium of claim 11, wherein when the cells of the set are configured for the dynamic beta offset, the processing circuitry is configured to dynamically apply the beta offset value indicated by the DCI format to transmissions in the PUSCH of the cell having the smallest service cell index.

13. The computer-readable storage medium of claim 12, wherein when the DCI format does not include the beta-offset indicator, the cells of the set are configured for semi-static beta offset and the processing circuitry is configured to apply a beta offset value configured by higher-layer signalling to transmissions in the PUSCH of the cell having the smallest service cell index.

14. The computer-readable storage medium of claim 13, wherein the processing circuitry is configured to determine an amount of resources for the transmissions in the PUSCH based on a beta offset value.

15. The computer-readable storage medium of claim 13, wherein at least one of the CSI request field and the UL-SCH field has at least one bit with a value of one, wherein the UE is not expected to receive a DCI format with UL-SCH indicator of zero and CSI request of all zeros.

16. The computer-readable storage medium of claim 15, wherein at least one of the CSI request field and the UL-SCH field have a non-zero value, and
wherein when all bits of the CSI request field are zero, no CSI report is requested.

17. The computer-readable storage medium of claim 13, wherein when an frequency domain resource assignment (FDRA) field of the DCI format indicates that dynamic switch for resource allocation is configured for an active bandwidth part of a cell of the set, the processing circuitry is configured to determine that the cell is scheduled when either all bits of the FDRA field are not set to zero or when all bits of the FDRA field are not set to one.

18. The apparatus of claim 17, wherein the processing circuitry is configured to apply the CSI request field and the UL-SCH indicator field to the cell of the set having a smallest service cell index indicated by the FDRA field of the DCI format.

19. An apparatus of a gNodeB (gNB) configured for operation in a fifth-generation new radio (5G NR) network, the apparatus comprising: processing circuitry; and memory, wherein the processing circuitry is configured to:
encode a downlink control information (DCI) format for transmission to a user equipment (UE), the DCI format scheduling multiple physical uplink shared channels (PUSCHs) in multiple cells with one PUSCH per cell, the multiple cells comprising a set of scheduled cells,
the DCI format comprising at least an uplink shared channel (UL-SCH) indicator field, and a channel-state information (CSI) request field,
the DCI format further comprising a beta-offset indicator when the cells of the set are configured for a dynamic beta offset,
wherein the processing circuitry is further configured to:
decode a CSI report received from the UE in a PUSCH of a cell having a smallest service cell index in accordance with the CSI request field; and
decode an UL-SCH received from the UE in the PUSCH of the cell having the smallest service cell index when indicated by the UL-SCH indicator field,
wherein a beta offset value indicated by the beta-offset indicator is applied by the UE to transmissions in the PUSCH when the cells of the set are configured for the dynamic beta offset.

20. The apparatus of claim 19, wherein when the cells of the set are configured for the dynamic beta offset, the UE dynamically applies the beta offset value indicated by the DCI format to transmissions in the PUSCH of the cell having the smallest service cell index, and
wherein when the DCI format does not include the beta-offset indicator, the cells of the set are configured for semi-static beta offset and the UE applies a beta offset value configured by higher-layer signalling to transmissions in the PUSCH of the cell having the smallest service cell index.
